(19) United States
(12) Patent Application Publication
(10) Pub. No.: US 2021/0297490 A1
(43) Pub. Date: Sep. 23, 2021

(54) MONITORING SYSTEM NETWORK AND METHOD FOR OPERATING A MONITORING SYSTEM NETWORK

(71) Applicant: Airbus Operations GmbH, Hamburg (DE)

(72) Inventors: Sophie SOULARD, HAMBURG (DE); Kai SCHULZE-REIMANN, HAMBURG (DE); Lars ROWOLD, HAMBURG (DE); Holger MEHRHOLZ, HAMBURG (DE); Jörn STÜBNER, HAMBURG (DE); Knut REFINGER, HAMBURG (DE)

(21) Appl. No.: 17/213,660

(22) Filed: Mar. 26, 2021

(30) Foreign Application Priority Data
Mar. 20, 2020 (DE) 102020204111.3

(51) Int. Cl. H04L 29/08; G06K 9/00; H04L 12/26

(52) U.S. Cl. CPC H04L 67/125; H04L 43/04; G06K 9/00744

(57) ABSTRACT

A monitoring system network has a plurality of sensor nodes with a sensor control device and at least one sensor element coupled to the sensor control device, a first hierarchical network layer with a plurality of network function nodes, each coupled to at least one of the plurality of sensor nodes, and a second hierarchical network layer with a plurality of network central nodes, each coupled to at least one of the plurality of network function nodes. The sensor control devices of the sensor nodes, the network function nodes and the network central nodes, in each case, have a data processing device and a configuration memory which is coupled to the data processing device and designed to store configuration data for different configurations of the respective data processing device.

### CROSS-REFERENCES TO RELATED APPLICATIONS

This application claims the benefit of the German patent application No. 102020204111.3 filed on Mar. 30, 2020, the entire disclosures of which are incorporated herein by way of reference.

### FIELD OF THE INVENTION

The invention relates to a monitoring system network as well as a method for operating a monitoring system network, in particular for use in civil or military aerospace.

### BACKGROUND OF THE INVENTION

Today's monitoring systems primarily offer real-time video recording and playback. For this purpose, conventional systems often require high computing power and correspondingly large storage capacities. Devices with such computing power and storage capacity are often implemented in central locations of monitoring systems.

EP 2 026 536 A1 discloses a sensor network system with sensors, network routers and network controllers. The network controllers can implement various network management functions.

### SUMMARY OF THE INVENTION

One of the objects of the invention is to find improved solutions for the implementation of monitoring system networks, wherein the required processing capacities can be distributed more efficiently across the network elements.

According to a first aspect of the invention, a monitoring system network comprises a plurality of sensor nodes with a sensor control device and at least one sensor element coupled to the sensor control device, a first hierarchical network level with a plurality of network function nodes, each of which is coupled to at least one of the plurality of sensor nodes, and a second hierarchical network level with a plurality of network central nodes, each of which is coupled to at least one of the plurality of network function nodes. The sensor control devices of the sensor nodes, the network function nodes and the network central nodes in each case have a data processing device and a configuration memory which is coupled to the data processing device and designed to store configuration data for different configurations of the respective data processing device.

According to a second aspect of the invention, a method for operating a monitoring system network includes the steps of capturing sensor data signals by sensor elements included in sensor nodes of the monitoring system network; forwarding the captured sensor data signals to sensor control devices included in the sensor nodes of the monitoring system network; forwarding sensor data signals at least partially processed by the sensor control devices to network function nodes of the monitoring system network; performing first further processing steps on the sensor data signals at least partially processed by the sensor control devices in a data processing device of the network function node; and performing second processing steps on the sensor data signals further processed by the network function nodes in a data processing device of network central nodes of the monitoring system network coupled to the network function nodes. The first and second forwarding steps through the data processing device are performed according to one configuration, read from a configuration memory coupled to the respective data processing device, of a plurality of configurations stored in the configuration memory.

One of the main ideas of the invention is to create a modular architecture of a monitoring system network, which is able to distribute the required data processing and/or data storage capacity over a larger number of network elements. A particular advantage in the solutions of the invention is that it allows the resource distribution over a larger number of network elements, enabling data processing and/or data storage in locations that are not necessarily limited to the location of data collection or creation or the location of the central control of the network. In addition, the required data processing and data storage capacity may vary during the operation of the monitoring system network and the monitoring system network can be adequately adapted due to the modular design.

Furthermore, the amount of data that is passed through the network can be appropriately limited by the fact that certain data processing and/or data storage operations have to be performed only over short distances in the network by locally separated processing processes distributed over several network elements. This makes it possible to advantageously reduce the maximum required data transfer capacity while maintaining performance.

If the monitoring system network requires more data processing and/or data storage capacity, the modular architecture allows new network elements to be added to the hierarchically appropriate locations of the network without the need to redesign the network as a whole. This flexibility allows the monitoring system network to operate efficiently in terms of cost, maintenance, and implementation.

In addition, another of the main ideas of the invention is to flexibly design a monitoring system network for different application scenarios by implementing a variable configurability at different hierarchical levels of the monitoring system network. This allows the same topology of the monitoring system network to be used for different applications or different combinations of different applications. Advantageously, it is possible to reconfigure monitoring system networks efficiently and without much effort on demand during ongoing operation. The lead time for the design, procurement, and implementation of network elements can be advantageously reduced by using variably usable similar standard network elements. In addition, the need for future application scenarios can be met in a forward-looking manner by flexibly configurable monitoring system networks.

Advantageous embodiments and further developments result from the further subordinate claims as well as from the description with reference to the figures.

According to some embodiments of the monitoring system network, the configuration memories may in each case be designed, on the basis of an external configuration control signal, to read one of several sets of configuration data and to execute it on the associated data processing device in order to set a specific operating configuration in the data processing device.

According to some embodiments of the monitoring system network, the sensor elements may have digital imaging devices and/or acoustic sensors designed to capture a sound pressure level and/or sound frequencies.

According to some other embodiments of the monitoring system network, the configuration data may be designed to implement video monitoring functions for capturing and detecting the presence of an object or person, for detecting an object class of a captured object, for capturing and detecting part of a captured object, for counting objects or persons in general or of a specific object class and/or for tracking the movement of an object or person, by means of the digital imaging devices.

According to some other embodiments of the monitoring system network, the network function nodes may have a data processing device and/or a permanent or temporary memory device.

According to some other embodiments of the monitoring system network, the network central nodes may have a data processing device and/or a permanent or temporary memory device with a data processing and/or data storage capacity which is greater than the data processing and/or data storage capacity of the network function nodes.

According to some embodiments of the method, the network function nodes may be coupled to each other in a star topology, a daisy chain topology, a bus topology, or a meshed topology.

According to some embodiments of the method, the data processing device can be configured via an external configuration control signal, with the aid of which one of several sets of configuration data is read from the configuration memory and executed on the associated data processing device in order to set a specific operating configuration in the data processing device.

According to some other embodiments of the method, the first further processing steps and/or the second further processing steps may have data processing or data storage functions.

The above designs and developments can be combined with each other as desired if this is appropriate. Other possible embodiments, developments and implementations of the invention also include combinations not explicitly mentioned of features of the invention described previously or below with regard to the exemplary embodiments. In particular, the person skilled in the art will also add individual aspects as improvements or additions to the respective basic form of the present invention.

### BRIEF DESCRIPTION OF THE DRAWINGS

The present invention is explained below on the basis of the exemplary embodiments given in the schematic figures. In the figures:

FIG. 1 shows a schematic block diagram of the topology of a monitoring system network according to an embodiment of the invention;

FIG. 2 shows a schematic block diagram of a sensor node for a monitoring system network according to FIG. 1;

FIG. 3 shows a schematic block diagram of a network function node for a monitoring system network according to FIG. 1;

FIG. 4 shows a flow diagram of a first method for operating a monitoring system network according to another embodiment of the invention;

FIG. 5 shows an aircraft with a monitoring system network according to another embodiment of the invention; and

FIG. 6 shows a flow diagram of a second method for operating a monitoring system network according to another embodiment of the invention.

The enclosed figures are intended to convey a further understanding of the embodiments of the invention. They illustrate embodiments and are used in connection with the description to explain principles and concepts of the invention. Other embodiments and many of the mentioned advantages arise with regard to the drawings. The elements of the drawings are not necessarily shown to scale. Direction-giving terminology such as “top”, “bottom”, “left”, “right”, “above”, “below”, “horizontal”, “vertical”, “front”, “back” and similar information is used only for explanatory purposes and not to limit the generality to specific embodiments as shown in the figures.

In the figures of the drawing, identical, functionally equivalent, and identically acting elements, features, and components are provided with the same reference characters, unless stated otherwise.

### DESCRIPTION OF THE PREFERRED EMBODIMENTS

The following description refers to self-learning algorithms used in an artificial intelligence (AI) system. Generally speaking, a self-learning algorithm recreates cognitive functions which are associated with human power of thought according to human judgment. By adding new training information, the self-learning algorithm can dynamically adapt the findings gained from old training information to the changed circumstances in order to recognize and extrapolate patterns and regularities in the totality of the training information.

In self-learning algorithms within the meaning of the present invention, all kinds of training producing a gain in human knowledge can be used, such as supervised learning, partially supervised learning, independent learning based on generative, non-generative or deeply adversarial networks (AN), strengthening learning or active learning. Feature-based learning (“representation learning”) can be used in each instance. The self-learning algorithms within the meaning of the present invention can in particular carry out iterative adaptation of parameters and features to be learned via feedback analysis.

A self-learning algorithm within the meaning of the present invention can be used on a support vector network (SVN), a neural network such as a convolutional neural network (CNN), a Kohonen network, a recurrent neural network, a time-delayed neural network (TDNN), or an oscillating neural network (ONN), a random forest classifier, a decision tree classifier, a Monte Carlo network, or a Bayesian classifier. A self-learning algorithm within the meaning of the present invention can use property-hereditarian algorithms, k-means algorithms such as Lloyd or MacQueen's algorithms or TD learning algorithms such as SARSA or Q-Learning.

The following description refers to distributed applications which can be implemented in a distributed (IT) system. Distributed applications within the meaning of this disclosure are all complex application programs which can run on several computers or processors and for which the participating computers or processors exchange information with each other which is relevant for execution. Distributed applications divide a task of the entire system into individual components or constituents of the entire system, so that in order to accomplish the overall task, all components or constituents must participate in the application and communicate with each other.

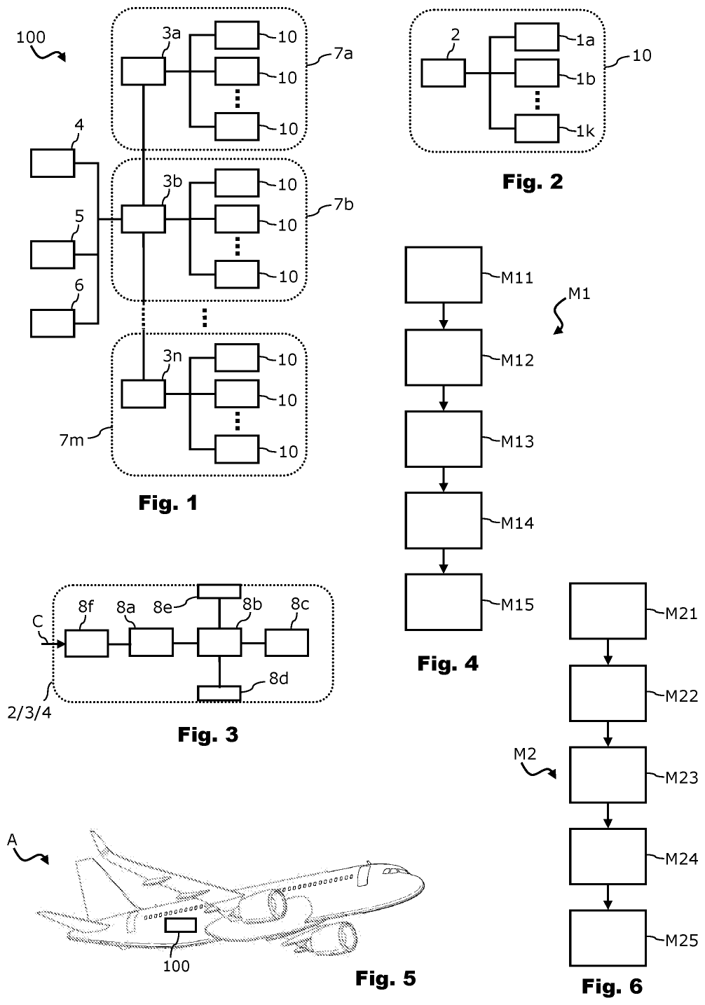

FIG. 1 shows an exemplary illustration of a topology of a monitoring system network 100, which can be used, for example, in an aircraft or a spacecraft, such as the aircraft A shown in FIG. 5. In FIGS. 2 and 3, various network elements of the monitoring system network 100 are shown as examples and in a higher degree of detail. The monitoring system network 100 basically comprises a number of hierarchically organized network nodes. At the highest hierarchical level, the monitoring system network 100 comprises one or more network central nodes 4. For example, a network central node 4 is shown in FIG. 1, wherein however, it should be clear that any number of network central nodes 4 can also be possible. At the next higher hierarchical level, the monitoring system network 100 contains one or more network function nodes 3a, 3b, . . . , 3n, which are coupled to one or more of the network central nodes 4. As an example, in FIG. 1 three network central nodes 4 are shown, although it should be clear that any number n of network function nodes can also be possible.

Each of the network function nodes 3a, 3b, . . . , 3n can be coupled to one or more sensor nodes 10 at a lowest hierarchical network level. The number of coupled sensor nodes 10 per network function node 3a, 3b, . . . , 3n is shown as three in the example of FIG. 1; however, it should be clear that more or fewer than three sensor nodes 10 can also be coupled to a network function node and that the number of sensor nodes 10 coupled to a network function node 3a, 3b, . . . , 3n can vary from network function node to network function node. The network function nodes 3a, 3b, . . . , 3n together with the corresponding sensor nodes 10 can form a local network node 7a, 7b, . . . , 7m. The number of local network nodes 7a, 7b, . . . , 7m is shown as three in FIG. 1 as an example, but it should be clear that any number m of local network nodes can also be possible.

The network function nodes 3a, 3b, . . . , 3n and/or the network central nodes 4 can also be coupled to devices at a higher level, such as other systems on board an aircraft—illustrated here as avionics devices 5—or to a display device 6 in an aircraft, such as a control panel for crew members.

FIG. 1 further illustrates that the network function nodes 3a, 3b, . . . , 3n can be connected in a star topology. However, it may also be possible that the network function nodes 3a, 3b, . . . , 3n are coupled to each other in another network topology, such as a ring topology, a daisy chain topology, a meshed topology, a bus topology, or any other suitable network topology.

FIG. 2 shows a sensor node 10, many of which can be combined or connected into a sensor network. The sensor node 10 can comprise a sensor control device 2 as well as one or more sensor elements 1a, 1b, . . . , 1k. A possible design of the sensor control device 2 is illustrated by way of example in FIG. 3. The sensor control device 2 may have a power supply source (not shown), a data processing device 8a such as a logic circuit or a microprocessor, a permanent or temporary memory device 8c and/or a network communication module 8b. Alternatively or in addition, the sensor node 10 or the sensor control device 2 or one or more of the sensor elements 1a, 1b, . . . , 1k may be unpowered or passive and may obtain energy from an external device or other energy source.

The power supply source may include, for example, a battery or accumulator, a photovoltaic cell and/or a continuous power supply by an external power source, such as by a mains connection. The memory device 8c may include, for example, all computer-readable media, such as volatile and/or non-volatile media, replaceable and/or non-replaceable media, and may be designed for storing computer-readable data in permanent or semi-permanent form. The memory device 8c may be implemented with any data storage technology. It may also be possible that the memory device 8c stores data in a form that can be sampled or otherwise converted into a form which can then be stored on a computer-readable medium.

The sensor node 10 can transmit data signals via the network communication module 8b of the sensor control device 2, for example via a communication interface 8e on the network side and/or a communication interface 8d on the sensor side. Optionally, the sensor node 10 can also receive data signals from outside via the network communication module 8b. Data signals within the meaning of the present disclosure include any type of current signal, voltage signal, magnetic signal, or optical signal in storable, transferable, combinable, comparable, or otherwise manipulable formats. The data signal transmission through the network communication module 8b can be done wirelessly, wired, via infrared, via optical transmission paths or other communication technologies. For this purpose, the network communication module 8b may comprise appropriate data interfaces such as wired connections, optical ports, or antennas for wireless communication. The communication interfaces 8d and 8e may have corresponding data interfaces.

The sensor node 10 may contain any type of data processing capacity in the form of a data processing device 8a, such as a hardware logic circuit, an application-specific integrated circuit (ASIC), a programmable logic circuit (PLC), a microcomputer, microcontroller, or programmable microprocessor. The data processing facility 8a can provide (intermediate) storage, manipulation, comparison and/or formatting of data signals. For this purpose, the sensor node 10 can have one or more programs stored in a memory for the operation of the sensor node 10. If a data processing device 8a uses a hardware logic circuit, the logic circuit may have a logical structure with which the sensor node 10 or the sensor control device 2 is operated.

The sensor node 10 contains one or more sensor elements 1a, 1b, . . . , 1k, which are able to detect a parameter of an environment in which the sensor node 10 is located and output a data signal based thereon. The sensor elements 1a, 1b, 1k can capture at least one detection parameter from a group of optical, acoustic, hydraulic, thermal, acceleration-related, magnetic, biological, and chemical parameters. Optical parameters may include, for example, characterizing parameters for infrared, visible, and/or ultraviolet light. The sensor elements 1a, 1b, . . . , 1k may, for example, and without restriction of the general applicability, have photosensors for detecting a light level or a change in the light level, temperature sensors for detecting a temperature, audio sensors for detecting sound and/or motion sensors for detecting movements. The sensor elements 1a, 1b, . . . , 1k may, for example, have digital imaging devices, such as CCD cameras or CMOS sensors, which can generate data in relation to captured infrared light sources, sources of visible light, or sources of ultraviolet light.

Using sensor elements 1a, 1b, . . . , 1k, the sensor node 10 can automatically capture data related to a parameter of the sensor node environment. The captured data can be recorded in the sensor control device 2 of the sensor elements 1a, 1b, . . . , 1k and stored locally or pre-processed. The sensor control device 2 can then transfer the locally stored data to the outside, for example to a network function node 3, to which the sensor node 10 is connected. The sensor control device 2 can, for example, receive video and audio data signals from the sensor elements 1a, 1b, . . . , 1k and convert them into a format suitable for further processing. In addition, in the sensor control device 2 analytical processing steps can be performed on the received video and audio data signals from the sensor elements 1a, 1b, . . . , 1k. These analytical processing steps can be limited to basic functions in order to keep the power requirements, installation space and data processing or storage capacities of the electronic components of the sensor control device 2 as small as necessary.

If the sensor elements 1a, 1b, . . . , 1k are acoustic sensors, for example, sound pressure levels and/or sound frequencies can be captured, and corresponding data signals can be transmitted to the sensor control device 2. The capture by the sensor elements 1a, 1b, . . . , 1k can be carried out in any way, for example continuously, intermittently, sporadically, occasionally and/or on request. As a further example, the sensor elements 1a, 1b, . . . , 1k may be digital cameras, which perform optical sampling of the spatial environment of the sensor node 10 periodically, about once per second, and transmit data signals that relate to the captured images together with a time track. In another example, the sensor elements 1a, 1b, . . . , 1k may be temperature sensors that detect temperature changes in predefined temperature intervals and transmit a temperature change together with the time at which it occurred to the sensor control device 2.

Some or certain of the sensor elements 1a, 1b, . . . , 1k can, for example, record operating parameters of the sensor node 10 itself, such as the remaining battery charge or the radio signal strength for wireless communication. The sensor data, including the data relating to a captured parameter, are transmitted to a receiver from the sensor node 10 via the sensor control device 2 thereof in any signal form. The receiver may be, for example, another sensor node 10, a network function node 3, a network central node 4, or any other data receiver, such as avionics devices 5 on board an aircraft. The sensor data may contain a time and/or date stamp at which the data relating to a parameter has been captured.

Network function nodes 3 and/or network central nodes 4 may be constructed in a similar way to the sensor control device 2: an exemplary implementation is illustrated in FIG. 3. A network function node 3 may have a power source (not shown), a data processing device 8a such as a logic circuit or a microprocessor, a permanent or temporary memory device 8c and/or a network communication module 8b. Alternatively or additionally, the network function node 3 may be unpowered or passive and may draw energy from an external device or other power source.

The power supply source may include, for example, a battery or accumulator, a photovoltaic cell and/or a continuous power supply by an external power source, such as by a power supply. The memory device 8c may include, for example, all computer-readable media, such as volatile and/or non-volatile media, replaceable and/or non-replaceable media, and may be designed for storing computer-readable data in permanent or semi-permanent form. The memory device 8c may be implemented with any data storage technology. It may also be possible that the memory device 8c stores data in a form that can be sampled or otherwise converted into a form which can then be stored on a computer-readable medium.

The network function node 3 can transmit data signals via the network communication module 8b, for example via a communication interface 8e on the central node side and/or a communication interface 8d on the sensor node side. Optionally, the network function node 3 can also receive data signals from outside via the network communication module 8b. Data signals within the meaning of the present disclosure include any type of current signal, voltage signal, magnetic signal, or optical signal in storable, transferable, combinable, comparable, or otherwise manipulable formats. The data signal transmission by the network communication module 8b can be done wirelessly, wired, via infrared, optical transmission paths or other communication technologies. For this purpose, the network communication module 8b may include appropriate data interfaces such as wired connections, optical ports, or antennas for wireless communication. The communication interfaces 8d and 8e may have corresponding data interfaces.

The network function node 3 may contain any type of data processing capacity in the form of a data processing device 8a, such as a hardware logic circuit, an application-specific integrated circuit (ASIC), a programmable logic circuit (PLC), a microcomputer, microcontroller, or programmable microprocessor. The data processing facility 8a can provide (intermediate) storage, manipulation, comparison and/or formatting of data signals. For this purpose, the network function node 3 may have one or more programs stored in a memory for the operation of the network function node 3. If a data processing device 8a uses a hardware logic circuit, the logic circuit may have a logical structure by means of which the network function node 3 is operated.

For example, the network function nodes 3 can exchange data with each other and with network central nodes 4, provide computing power for analytical processing steps network-wide, store data signals from sensor nodes 10, share processing load and data storage capacities among themselves, and manage interfaces to aircraft systems. The network function nodes 3 may be installed locally, for example distributed in an aircraft cabin. The selection of the installation locations may be based on the arrangement of the sensor nodes 10 in an aircraft and, if applicable, the expected amount of data of data signals captured by the sensor nodes 10.

A network central node 4 may have a power supply source (not shown), a data processing device 8a such as a logic circuit or a microprocessor, a permanent or temporary memory device 8c and/or a network communication module 8b. Alternatively or additionally, the network central node 4 may be unpowered or passive and may obtain energy from an external device or other power source.

The power supply source may include, for example, a battery or accumulator, a photovoltaic cell and/or a continuous power supply by an external power source, such as by a power supply. The memory device 8c may include, for example, all computer-readable media, such as volatile and/or non-volatile media, replaceable and/or non-replaceable media, and may be designed for storing computer-readable data in permanent or semi-permanent form. The memory device 8c may be implemented with any data storage technology. It may also be possible that the memory device 8c stores data in a form that can be sampled or otherwise converted into a form which can then be stored on a computer-readable medium.

The network central node 4 may transmit data signals via the network communication module 8b, for example via a communication interface 8e on the network side and/or a communication interface 8d on the function node side. Optionally, the network central node 4 may also receive data signals from outside via the network communication module 8b. Data signals within the meaning of the present disclosure include any type of current signal, voltage signal, magnetic signal, or optical signal in storable, transferable, combinable, comparable, or otherwise manipulable formats. The data signal transmission by the network communication module 8b can be done wirelessly, wired, via infrared, optical transmission paths or other communication technologies. For this purpose, the network communication module 8b may include appropriate data interfaces such as wired connections, optical ports, or antennas for wireless communication. The communication interfaces 8d and 8e may have corresponding data interfaces.

The network central node 4 can contain any type of data processing capacity in the form of a data processing device 8a, such as a hardware logic circuit, an application-specific integrated circuit (ASIC), a programmable logic circuit (PLC), a microcomputer, microcontroller, or programmable microprocessor. The data processing facility 8a may provide (intermediate) storage, manipulation, comparison and/or formatting of data signals. For this purpose, the network central node 4 may have one or more programs stored in a memory for the operation of the network central node 4. If a data processing device 8a uses a hardware logic circuit, the logic circuit may have a logical structure by means of which the network central node 4 is operated.

Network central nodes 4 may have higher computing and storage capacity compared to network function nodes 3. The number of network central nodes 4 may be small compared to the number of network function nodes 3 in a monitoring system network 100. Network central nodes 4 may be installed in locations with appropriate cooling performance, for example in central server racks in the electronics compartment of an aircraft, to ensure relatively high data processing and storage capacity. The network function nodes 3, for example, may be passively cooled and arranged behind the interior trim of the aircraft fuselage, for example.

The sensor control devices 2, network function node 3 and network central nodes 4 may be equipped with individually configurable basic functions. For this purpose, each of the sensor control devices 2 or each of the network function nodes 3 and network central nodes 4 may have a configuration memory 8f, in which configuration data for different configurations of the respective data processing device 8a are stored. Using an external configuration control signal C, the configuration memory 8f can be controlled to read one of several sets of configuration data and execute it on the data processing device 8a to set a specific operating configuration in the data processing device 8a. The configuration data may be written or modified or adjusted via an access interface (not shown) by means of an external access to the configuration memory 8f.

The configuration data can be customized according to the type of network element, i.e., sensor control devices 2, network function nodes 3 and network central nodes 4 may have different configuration states depending on the type of device. This allows a monitoring system network 100 to be implemented that includes a predefined number of basic functions in different network elements. Different application scenarios and individualized operating functions can be configured by appropriate control of the configuration memories 8f of the sensor control devices 2, network function nodes 3 and network central nodes 4 with external configuration control signals C.

For example, in the case of sensor nodes 10 with optical sensor elements 1a, 1b, . . . , 1k such as image acquisition devices, various functions can be configured for image-based monitoring or video monitoring. Examples of such video monitoring functions include capturing and detecting the presence of an object or person, detecting an object class of a captured object, capturing, and detecting part of a captured object, counting objects or persons in general or of a specific object class, tracking the movement of an object or person, and the like.

For example, to implement a tracking feature for one person, one of the sensor nodes 10 can be configured to capture a group of people and another of the sensor nodes 10 or the same sensor node 10 can be configured to separate a particular person and track them in the image. As another example, to implement a person count function, one of the sensor nodes 10 can be configured to capture a group of people, and another of the sensor nodes 10 or the same sensor node 10 can be configured to mark the individual captured persons and count the marked persons.

Another example can be the implementation of echo localization functions for sensor nodes 10 with ultrasonic encoders and sensors as sensor elements 1a, 1b, . . . , 1k. For this purpose, a first group of locally selected sensor nodes 10 can act as ultrasonic encoders, whose sensor elements 1a, 1b, . . . , 1k emit ultrasonic signals that are reflected by objects or persons. A second group of locally selected sensor nodes 10 can be set up as ultrasonic receivers, which are used to receive the ultrasonic signals reflected by objects or persons as echo signals. For echo localization or echolocation, the emitted ultrasonic signals are bounced back from or reflected by obstacles. The transition time of the waves between sending and receiving the echo allows a location-resolved distance to the obstacle, such as an object or a person, to be determined. When using a spatially distributed array of ultrasonic encoders, it is possible to derive conclusions about the spatial direction and the size of the object or person from the transition time differences between the individual ultrasonic encoders. Echo localization makes it possible to efficiently implement monitoring systems that do not allow conclusions about the identity of individuals as easily as video monitoring systems but can still reliably detect important monitoring parameters such as an unauthorized stay in a particular location, unusual behavior, or signs of needed assistance, such as a fall or medical emergency.

The sensor control devices 2, network function nodes 3 and network central nodes 4 may, for example, implement self-learning algorithms to evaluate video and/or audio data signals with artificial intelligence and to enable automated analysis of the image or sound content of the recorded video or audio data signals. For the implementation of self-learning algorithms, but also for other non-AI-bound distributed applications, sensor control devices 2, network function nodes 3 and network central nodes 4 can form appropriate distributed IT systems.

FIG. 4 shows a schematic flow diagram of steps of a first method M1 for operating a monitoring system network, in particular for use in civil or military air travel or space travel such as on board a passenger aircraft, for example the aircraft A of FIG. 5. The method M1 can be used, for example, in the monitoring system network 100 shown in connection with FIGS. 1 to 3.

In a first step M11 the capture of sensor data signals is carried out by sensor elements 1a; . . . ; 1k contained in sensor nodes 10 of the monitoring system network 100. The captured sensor data signals are forwarded in a second step M12 to sensor control devices 2 contained in the sensor nodes 10 of the monitoring system network 100, where they are processed at least partially by the sensor control devices 2. These sensor data signals processed at least partially by the sensor control devices 2 are forwarded in a third step M13 to network function nodes 3 of the monitoring system network 100. Each of the network function nodes 3, which can be networked in a star topology, a daisy chain topology, a meshed topology, or a bus topology, can be associated with one or more of the sensor nodes 10.

In a fourth step M14, a performance M14 of first further processing steps, such as data processing or data storage functions, is carried out in the network function nodes 3 on the sensor data signals at least partially processed by the sensor control devices 2. Thereafter, second further processing steps, such as data processing or data storage functions, can be performed in a fifth step M15 in network central nodes 4 of the monitoring system network 100 on the sensor data signals further processed by the network function nodes 3.

The at least partial processing by the sensor control devices 2, the first further processing steps and the second further processing steps are parts of a distributed application for the evaluation of the sensor data signals captured by the sensor elements 1a; . . . ; 1k of the sensor nodes 10. The network components of the monitoring system network 100 act as parts of a distributed (IT) system, for example for the automated analysis by means of self-learning algorithms of image or sound contents of video or audio data signals captured by the sensor elements (1a; . . . ; 1k).

FIG. 6 shows a schematic flow diagram of steps of a second method M2 for operating a monitoring system network, in particular for use in civil or military air travel or space travel, such as on board a passenger aircraft, for example the aircraft A of FIG. 5. The method M2 can be used, for example, in the monitoring system network 100 shown and explained in connection with FIGS. 1 to 3.

In a first step M21 the capture of sensor data signals is carried out by sensor elements 1a; . . . ; 1k contained in sensor nodes 10 of the monitoring system network 100. The captured sensor data signals are forwarded in a second step M22 to sensor control devices 2 contained in the sensor nodes 10 of the monitoring system network 100. These sensor data signals processed at least partially by the sensor control devices 2 are forwarded in a third step M23 to network function nodes 3 of the monitoring system network 100. Each of the network function nodes 3, which can be networked in a star topology, a daisy chain topology, a meshed topology, or a bus topology, can be associated with one or more of the sensor nodes 10.

In a fourth step M24 a performance of first further processing steps is carried out in a data processing device 8a of the network function node 3 on the sensor data signals at least partially processed by the sensor control devices 2. Thereafter, second further processing steps, such as data processing or data storage functions, can be performed in a fifth step M25 on the sensor data signals further processed by the network function nodes 3 in a data processing device 8a of network central nodes 4 of the monitoring system network 100 coupled to the network function nodes 3.

The first and second forwarding steps through the data processing device 8a are performed according to one configuration of a plurality of configurations. This plurality of configurations is stored in the configuration memory 8f, which is coupled to the respective data processing device 8a.

In the previous detailed description, various features have been summarized in one or more examples to improve the compelling nature of the presentation. However, it should be clear that the above description is merely illustrative, but by no means restrictive. It is used to cover all alternatives, modifications and equivalents of the various features and embodiments. Many other examples will be immediately and directly clear to the person skilled in the art on the basis of his professional knowledge in view of the above description.

The exemplary embodiments were selected and described in order to present the principles underlying the invention and their application possibilities in practice in the best possible way. This allows persons skilled in the art to optimally modify and use the invention and the various embodiments thereof with regard to the intended purpose.

While at least one exemplary embodiment of the present invention(s) is disclosed herein, it should be understood that modifications, substitutions and alternatives may be apparent to one of ordinary skill in the art and can be made without departing from the scope of this disclosure. This disclosure is intended to cover any adaptations or variations of the exemplary embodiment(s). In addition, in this disclosure, the terms “including”, “having”, “comprise” or “comprising” do not exclude other elements or steps, the terms “a” or “one” do not exclude a plural number, and the term “or” means either or both. Furthermore, characteristics or steps which have been described may also be used in combination with other characteristics or steps and in any order unless the disclosure or context suggests otherwise. This disclosure hereby incorporates by reference the complete disclosure of any patent or application from which it claims benefit or priority.

1. A monitoring system network, comprising:
a plurality of sensor nodes with a sensor control device and at least one sensor element coupled to the sensor control device;
a first hierarchical network layer with a plurality of network function nodes, each coupled to at least one of the plurality of sensor nodes; and
a second hierarchical network layer with a plurality of network central nodes, each coupled to at least one of the plurality of network function nodes,
wherein the sensor control devices of the sensor nodes, the network function nodes and the network central nodes in each case have a data processing device and a configuration memory which is coupled to the data processing device and configured to store configuration data for different configurations of the respective data processing device.

2. The monitoring system network according to claim 1, wherein the sensor elements comprise at least one of digital imaging devices or acoustic sensors configured to capture at least one of a sound pressure level or sound frequencies.

3. The monitoring system network according to claim 2, wherein the configuration data are configured to implement video monitoring functions for at least one of
capturing and detecting a presence of an object or person,
detecting an object class of a captured object,
capturing and detecting part of a captured object,
counting objects or persons in general or of a specific object class, or
tracking a movement of an object or person,
via the digital imaging devices.

4. The monitoring system network according to claim 1, wherein the configuration memory is in each case configured, based on an external configuration control signal, to read one of several sets of configuration data and to execute the one of several sets of configuration data on the associated data processing device in order to set a specific operating configuration in the data processing device.

5. The monitoring system network according to claim 1, wherein the network function nodes comprise a permanent or temporary memory device which is coupled to the data processing device.

6. The monitoring system network according to claim 5, wherein the network central nodes comprise at least one of the data processing device or the permanent or temporary memory device with at least one of a data processing or data storage capacity which is greater than the at least one of the data processing or data storage capacity of the network function nodes.

7. A method for operating a monitoring system network, comprising:
capturing sensor data signals by sensor elements contained in sensor nodes of the monitoring system network;
forwarding the captured sensor data signals to sensor control devices in the sensor nodes of the monitoring system network;
forwarding sensor data signals at least partially processed by the sensor control devices to network function nodes of the monitoring system network;
performing first further processing steps on the sensor data signals at least partially processed by the sensor control devices in a data processing device of the network function node; and
performing second processing steps on the sensor data signals further processed by the network function nodes in a data processing device of network central nodes of the monitoring system network which are coupled to the network function nodes,
wherein the first and second forwarding steps through the data processing device are performed according to one configuration, read from a configuration memory coupled to the respective data processing device, of a plurality of configurations stored in the configuration memory.

8. The method according to claim 7, wherein the data processing device is configured via an external configuration control signal, the external configuration signal aiding a read of one of several sets of configuration data from the configuration memory and executed on the associated data processing device in order to set a specific operating configuration in the data processing device.

9. The method according to claim 7, wherein at least one of the first further processing steps or the second processing steps have data processing or data storage functions.

10. An aircraft with a monitoring system network according to claim 1.
